(19) United States
(12) Patent Application Publication
(10) Pub. No.: US 2003/0134254 A1
(43) Pub. Date: Jul. 17, 2003

(54) Hose and tip of suction apparatuses

(76) Inventor: Gianmaria Cominato Filho, Pindamonhangaba (BR)

Correspondence Address: SHAPIRO COHEN, P.O. BOX 3440, STATION D, OTTAWA, ON, K1P6P1, CA

(21) Appl. No.: 10/312,334

(22) PCT Filed: Dec. 5, 2001
(86) PCT No.: PCT/BR01/00145

(30) Foreign Application Priority Data
May 8, 2001 (BR) MU8101099

(51) Int. Cl. A61C 17/06

(52) U.S. Cl. 433/96

(57) ABSTRACT

Improvements related to hose and tip of suction apparatuses of densitry, particularly related to a suction pump having flexible hose having a plastic tube (1) and a tip (2) coupled at the free extrety, the tube (1) is a cylindrical body made of plastic and flexible material, the cylindrical body also comprises annular and self engageable corrugations (1b), an annular enlarged portion (1c) is provided at the extremity of the tube (1) for connecting to the extremity (2b) of the tip (2); said tip has a cylindrical shape, having an extremity (2a) with concentric and annular corrugations (3); the internal base (4) of the portion (3) has a central hole (5); the cylindrical wall (2c) of the tip (2) has longitudinal and equidistant slots (6) positioned at the middle of the said wall (2c); the above improvements permit an industrial cost reduction in the obtention process of the tube (1) and enhance the operational performance of the tip (2).

### BACKGROUND OF THE INVENTION

The present Uitility Model invention refers to novel features of hose and tip of a suction apparatus, particularly, this invention refers to a dentistry equipment for suction of saliva from the patient mouth during the tooth treatment.

Dental surgeons apply many kinds of known dentistry accessories in tooth and/or mouth related treatment. The saliva suction apparatus is one of them.

Generally, suction apparatuses comprise a suction pump having a flexible hose which comprises a plastic tube having a romvable tip; the tip can be also fixed to the plastic tube.

Plastic tubes are manufactured for present a constant cylindrical cross section and the walls of said tubes have thickness for involve a metallic wire which is longitudinally placed paralel to the axis of the tube. This permits the tube be manually curved, assuming different forms for better accommodation into the mouth cavity. The metallic wire is to maintain the desired shape of the plastic tube.

Tips of the art comprise a funnel type tubular plastic piece having a connection end for connect the plastic tube and a narrowed end which is perforated by lateral slots, on the tip walls, and a terminal hole in its extreme point.

Some limitations are found in the conventional plastic tube and tips of the art. The plastic tube has an expensive cost in view of the metallic wire insertion, which is necessary for permit the tube be shaped fitted to the mouth cavity.

The tip is normally planar and it facilitates adhesion by suction of part of the tongue and/or mucous membrane inside the mouth and hurting the patient; the patitent under local anesthesia will feel hurt, not at the moment of the tooth treatment, but only after some hours.

### OBJECT OF THE INVENTION

For overcome the above mentioned limitations, the present invention proposes improvements in suction apparatuses by means of novel flexible hose which comprises plastic tube and tip parts for reduce the cost of manufacture of the tube and enhance the operation performance of the tip.

### SUMMARY OF THE INVENTION

The plastic tube is made of plastic and flexile material and the walls of the plastic tube are thin, comprising self engageable annular corrugations, for permit the tube assume curved forms and maintain said forms when needed.

The tip is cylindrically shaped, the extremity of the tip has an annular narrowed portion presenting a hole. The cylindrical walls of the tip have longitudinal and equidistant slots at their middle part. The upper part inside the tip have retention means for plastic tube extermity retention, prefereably, the retention means are formed by protuding means and locking holders.

Annular corrugations at the extremity of the tip form a chamber between the mucous membrane or tongue and the suction hole, avoiding hurting due to mouth tissue suction.

### BRIEF DESCRIPTION OF THE FIGURES

For complete the description of the present invention and offer a better comprehension of parts, features and details, a set of drawings are presented as follows:

FIG. 1 is an exploded view of the set of tube and tip of the invention;

FIG. 2 is a lateral view having a longitudinal cross section illustrating the assembled pieces of the invention.

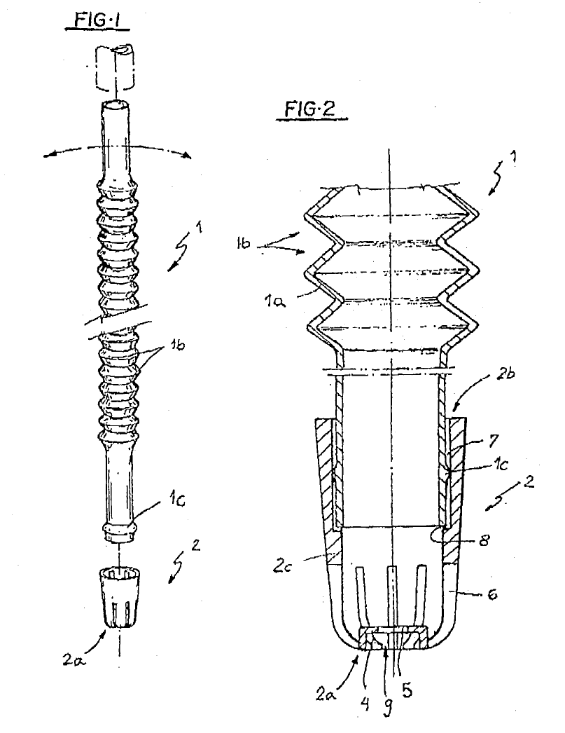

### DETAILED DESCRIPTION OF THE INVENTION

According to the drawings, the invention related to IMPROVEMENTS RELATED TO HOSE AND TIP OF SUCTION APPARATUSES for dentistry equipment or similars, particularly the suction apparatuses comprise a suction pump having a flexible hose having an extremity coupled to a plastic tube (1) and its respective removable tip (2).

According to the invention, the tube (1) has a cylindrical body made of flexible plastic material and the walls of the cylindrical tube (1a) are thin and present self engageable annular corrugations (1b) for permit curving the tube in different forms, maitaining said forms when necessary. The referred tube is made having an annular enlargement (1c) on its extremity.

The tip (2) has a cylindrical shape, its extremity (2a) has an annular, concentric and narrowed portion (3) containing a hole (5) in the inner base (4). The opposed extremity (2b) is able to engage on the enlarged extremity (1c) of the tube.

The cylindrical tip wail (2c) has longitudinal and equidistant slots (6) at the its middle part.

Retention means (7) of the enlarged extremity (1c) are placed at the inner upper portion (2) of the tip (1), prefereably being formed by protuding means (8) alternated by holders (9).

An intermediate chamber formed by annular corrugations (3) is placed between the mouth tissue and the suction hole (5) for avoid hurting by mouth tissue suction.

Thus, the novel plastic tube (1) and tip (2) assembly is good to impart advantageous features in view of the art, permitting cost reduction of the tube manufacture and avoid mouth hurting, as in the art, due the suction operation into the mouth cavity.

Any modifications, combinations or changes of the above described elements and/or involving known elements, must be seen like part of the scope of the invention.

1) IMPROVEMENTS RELATED TO HOSE AND TIP OF SUCTION APPARATUSES of dentistry, particularly related to a suction pump having flexible hose which comprises a plastic tube (1) and a removable or fixed tip (2), characterized in that the tube (1) is a cylindrical body made of plastic and flexible material, the tube (1) also comprises thin wall (1a) with annular and self engageable corrugations (1b), an annular enlarged portion (1c) is provided at the extremity of the tube for connecting to the extremity (2b) of the tip (2), the tip has a cylindrical shape, having an extremity (2a) opposed to the extremity (2b) and having an annular, concentric and narrowed portion (3); the internal base (4) of the portion (3) has a central hole (5); the cylindrical wall (2c) of the tip (2) has longitudinal and equidistant slots (6) positioned at the middle of the said wall (2c); retention means (7) of the extremity (1c) is placed at the middle of the upper part inside the tip (2).

2) IMPROVEMENTS, as in claim 1, characterized by retention means (7) having protusions (8) being alternated by tooth or holders (9).

3) IMPROVEMENTS, as in claim 1, characterized in that the annular corrugations (3) form an intermediate chamber (9).
